(19) United States
(12) Patent Application Publication
(10) Pub. No.: US 2021/0050947 A1
(43) Pub. Date: Feb. 18, 2021

(54) DOWNLINK FEEDBACK INFORMATION FOR UPLINK DATA RETRANSMISSION

(71) Applicant: MediaTek Inc., Hsinchu (TW)

(72) Inventor: Cheng-Rung Tsai, Hsinchu (TW)

(21) Appl. No.: 16/907,164

(22) Filed: Jun. 19, 2020

Related U.S. Application Data
(60) Provisional application No. 62/886,420, filed on Aug. 14, 2019.

(51) Int. Cl. H04L 1/18; H04W 72/04

(52) U.S. Cl. CPC H04L 1/1812; H04W 72/042

(57) ABSTRACT

A base station provides downlink feedback information (DFI) to a user equipment (UE) in a wireless network. The base station generates hybrid automatic repeat request (HARQ) acknowledgment (HARQ-ACK) information in a downlink control information (DCI) payload for each HARQ process associated with uplink transmission from the UE to the base station. The base station sets a DFI flag in the DCI payload to a predetermined value. The base station generates error detection bits based on the DCI payload, and sends DCI to the UE. The DCI includes the DCI payload and the error detection bits scrambled with a configured scheduling radio network temporary identifier (CS-RNTI).

### CROSS-REFERENCE TO RELATED APPLICATIONS

This application claims the benefit of U.S. Provisional Application No. 62/886,420 filed on Aug. 14, 2019, the entirety of which is incorporated by reference herein.

### TECHNICAL FIELD

Embodiments of the invention relate to wireless communications; more specifically, to the transmission of downlink feedback information to a user equipment (UE).

### BACKGROUND

The Fifth Generation New Radio (5G NR) is a telecommunication standard for mobile broadband communications. 5G NR is promulgated by the 3rd Generation Partnership Project (3GPP™) to significantly improve on performance metrics such as latency, reliability, throughput, etc. Some aspects of 5G NR may be based on the 4G Long Term Evolution (LTE) standard.

In a wireless network, a UE transmits data to a base station in an uplink transmission at a particular frequency and a particular time duration. The frequency and time duration are referred to as time-and-frequency resources, or resources. In one type of uplink transmission referred to as grant-based transmission, a UE requests a base station for scheduling uplink resources prior to uplink data transmission. The UE transmits data using the granted uplink resources after receiving a grant from the base station. In another type of uplink transmission referred to as configured grant (CG) transmission or grant-free transmission, a UE transmits data using pre-configured uplink resources, without specifically requesting the base station for a grant of the resources prior to the data transmission. Configured grant transmission can support lower latency than grant-based transmission, because configured grant allows a UE to transmit data without first requesting and receiving resource grants. However, grant-based transmission may support higher reliability than configured grant transmission, because configured grant access by multiple UEs may collide with one another when these UEs are pre-configured with the same set of uplink resources.

The existing wireless technology can be further improved with respect to reliability and latency to benefit operators and users of wireless communications. These improvements can apply to a wide range of multi-access technologies and the telecommunication standards that employ these technologies.

### SUMMARY

In one embodiment, a method is performed by a base station in a wireless network to provide downlink feedback information (DFI) to a UE. The base station generates hybrid automatic repeat request (HARQ) acknowledgment (HARQ-ACK) information in a downlink control information (DCI) payload for each HARQ process associated with uplink transmission from the UE to the base station. The base station sets a DFI flag in the DCI payload to a predetermined value. The base station generates error detection bits based on the DCI payload, and sends DCI to the UE. The DCI includes the DCI payload and the error detection bits scrambled with a configured scheduling radio network temporary identifier (CS-RNTI).

In another embodiment, a method is performed by a UE to receive DFI from a base station in a wireless network. The UE receives DCI from the base station, where the DCI includes error detection bits scrambled with a CS-RNTI. The UE validates that a DFI flag in the DCI is set to a predetermined value. When the DFI flag is validated, the UE obtains HARQ-ACK information from the DCI for each HARQ process associated with uplink transmission from the UE to the base station. The UE re-transmits data to the base station for one or more of the HARQ processes according to the HARQ-ACK information.

Other aspects and features will become apparent to those ordinarily skilled in the art upon review of the following description of specific embodiments in conjunction with the accompanying figures.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a diagram illustrating a network in which the embodiments of the present invention may be practiced.

FIG. 2 illustrates uplink data re-transmission based on downlink feedback information according to one embodiment.

FIG. 3 is a diagram illustrating an example of downlink control information (DCI) according to one embodiment.

FIG. 4 is a flow diagram illustrating a method for a base station to transmit downlink feedback information to a UE in a wireless network according to an embodiment.

FIG. 5 is a flow diagram illustrating a method for a UE to receive downlink feedback information from a base station in a wireless network according to one embodiment.

FIG. 6 is a block diagram illustrating an apparatus performing wireless communication according to one embodiment.

### DETAILED DESCRIPTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a mechanism for a base station to provide downlink feedback information (DFI) to a UE that performs configured grant uplink data transmission. According to the downlink feedback information, the UE determines whether to re-transmit the uplink data to the base station. The downlink feedback information may be part of a downlink control signal; e.g., the downlink control information (DCI) transmitted via a physical downlink control channel (PDCCH). The DFI may be in the form of a bitmap, herein referred to as a hybrid automatic repeat request (HARQ) acknowledgment (ACK) bitmap. The HARQ-ACK bitmap can also be called a HARQ-ACK codebook or a HARQ A/N codebook, where “A/N” is an abbreviation for acknowledgment or negative acknowledgment (ACK or NACK).

The UE sends uplink data via a physical uplink shared channel (PUSCH) to the base station in a number of HARQ processes, and the base station acknowledges receipt of the uplink data for each of these HARQ processes. The base station sends an ACK to the UE when data reception associated with a HARQ process is successful, and sends a NACK to the UE when data reception associated with a HARQ process is not successful; e.g., when the data is corrupted or no data is received. In one embodiment, the HARQ-ACK bitmap contains one bit for each corresponding HARQ process; e.g., a bit value of 1 indicates an ACK and a bit value of 0 indicates a NACK, or vice versa.

In some scenarios, a base station may send a DCI to a UE to provide control information for a purpose different from configured grant uplink transmission. For example, a base station may send a DCI to a UE to schedule one or more PUSCHs in a cell. A DCI with the error detection bits (e.g., cyclic redundancy check (CRC) bits) scrambled by configured scheduling radio network temporary identifier (CS-RNTI) indicates to the UE that the DCI provides control information for configured grant uplink transmission. However, DCI with CRC scrambled by CS-RNTI may be used to provide control information other than downlink feedback information. To differentiate that a DCI with CRC scrambled by CS-RNTI is transmitted for providing downlink feedback information or other purposes, a validation rule is defined for the transmission of downlink feedback information. In one example, one or more fields in the DCI may be defined for the validation. For example, a DFI flag in the DCI payload may be set to 1 to indicate that the DCI with CRC scrambled by CS-RNTI is transmitted for providing downlink feedback information for configured grant transmission (also referred to as “DFI” or “CG-DFI”).

When a DCI is transmitted for providing DFI, the DCI has at least the following features. One of the features is that the DCI has a predetermined format (e.g., DCI format 0_X, including one or more of DCI formats 0_0, 0_1 and 0_2). Another feature is that the error detection bits (e.g., CRC bits) appended to the DCI payload is scrambled by CS-RNTI. CS-RNTI may be used to identify the receiving UE or a group of UEs including the receiving UE. The receiving UE may be pre-configured with the CS-RNTI by a radio resource control (RRC) configuration. Yet another feature is that the DCI payload includes a DFI flag set to a predetermined value (e.g., 1).

3GPP™ Technical Specification TS 38.212 defines a number of DCI formats. Embodiments of the invention enhance the 3GPP™ definition to enable a base station to use DCI format 0_X (e.g., anyone of DCI format 0_0, 0_1 and 0_2) to provide downlink feedback information to a UE configured to perform configured grant uplink transmission.

The aforementioned mechanism enables a base station to send downlink feedback information to a UE to indicate whether uplink data re-transmission is necessary. Re-transmission of a HARQ process is necessary when the UE receives a NACK in the DCI for the HARQ process. If re-transmission is necessary, the UE may use the configured grant resources to re-transmit uplink data, without requesting an uplink grant from the base station for the re-transmission.

The disclosed method, as well as the apparatus and the computer product implementing the method, can be applied to wireless communication between a base station (e.g., a gNB in a 5G NR network) and UEs. It is noted that while the disclosed embodiments may be described herein using terminology commonly associated with 5G or NR wireless technologies, the present disclosure can be applied to other multi-access technologies and the telecommunication standards that employ these technologies.

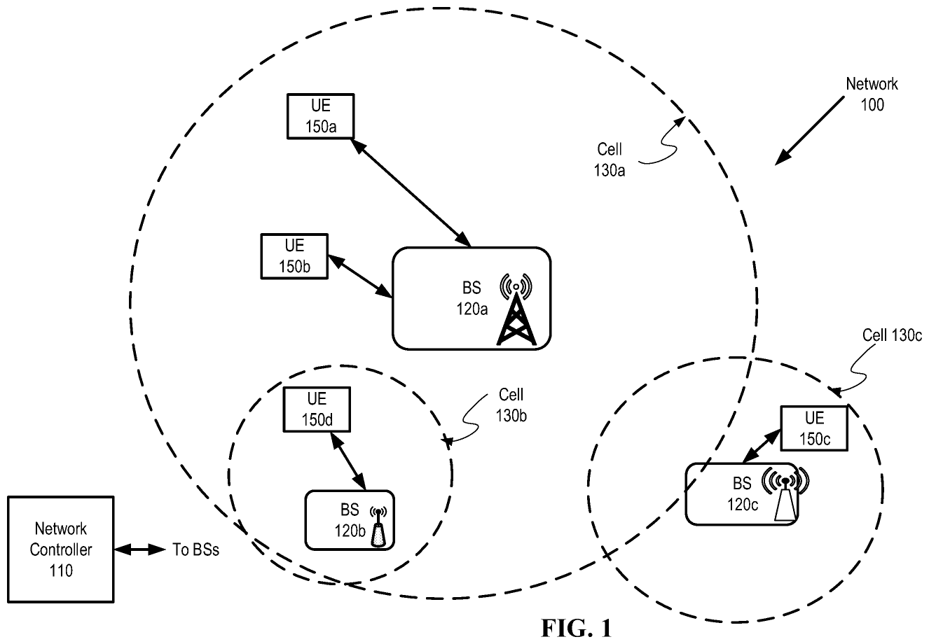

FIG. 1 is a diagram illustrating a network 100 in which embodiments of the present invention may be practiced. The network 100 is a wireless network which may be a 5G NR network. To simplify the discussion, the methods and apparatuses are described within the context of a 5G NR network. However, one of ordinary skill in the art would understand that the methods and apparatuses described herein may be applicable to a variety of other multi-access technologies and the telecommunication standards that employ these technologies.

The number and arrangement of components shown in FIG. 1 are provided as an example. In practice, the network 100 may include additional devices, fewer devices, different devices, or differently arranged devices than those shown in FIG. 1.

Referring to FIG. 1, the network 100 may include a number of base stations (shown as BSs), such as base stations 120a, 120b, and 120c, collectively referred to as the base stations 120. In some network environments such as a 5G NR network, a base station may be known as a gNodeB, a gNB, and/or the like. In an alternative network environment, a base station may be known by other names. Each base station 120 provides communication coverage for a particular geographic area known as a cell, such as a cell 130a, 130b or 130c, collectively referred to as cells 130. The radius of a cell size may range from several kilometers to a few meters. A base station may communicate with one or more other base stations or network entities directly or indirectly via a wireless or wireline backhaul.

A network controller 110 may be coupled to a set of base stations such as the base stations 120 to coordinate, configure, and control these base stations 120. The network controller 110 may communicate with the base stations 120 via a backhaul.

The network 100 further includes a number of UEs, such as UEs 150a, 150b, 150c and 150d, collectively referred to as the UEs 150. The UEs 150 may be anywhere in the network 100, and each UE 150 may be stationary or mobile. The UEs 150 may also be known by other names, such as a mobile station, a subscriber unit, and/or the like. Some of the UEs 150 may be implemented as part of a vehicle. Examples of the UEs 150 may include a cellular phone (e.g., a smartphone), a wireless communication device, a handheld device, a laptop computer, a cordless phone, a tablet, a gaming device, a wearable device, an entertainment device, a sensor, an infotainment device, an Internet-of-Things (IoT) device, or any device that can communicate via a wireless medium.

In one embodiment, the UEs 150 may communicate with their respective base stations 120 in their respective cells 130. A UE may have more than one serving cell; e.g., UE 150d may have both cell 130b and cell 130a as its serving cells. The transmission from a UE to a base station is called uplink transmission, and from a base station to a UE is called downlink transmission.

In one embodiment, each of the UEs 150 provides layer 3 functionalities through a radio resource control (RRC) layer, which is associated with the transfer of system information, connection control, and measurement configurations. Each of the UEs 150 further provides layer 2 functionalities through a packet data convergence protocol (PDCP) layer, a radio link control (RLC) layer and a medium access control (MAC) layer. The PDCP layer is associated with header compression/decompression, security, and handover support. The RLC layer is associated with the transfer of packet data units (PDUs), error correction through automatic repeat request (ARQ), concatenation, segmentation, and reassembly of RLC service data units (SDUs). The MAC layer is associated with the mapping between logical channels and transport channels, multiplexing of MAC SDUs onto transport blocks (TBs), de-multiplexing of MAC SDUs from TBs, scheduling information reporting, error correction through HARQ, priority handling, and logical channel prioritization. Each of the UEs 150 further provides layer 1 functionalities through a physical (PHY) layer, which is associated with error detection on the transport channels, forward error correction (FEC) coding/decoding of the transport channels, interleaving, rate matching, mapping onto physical channels, modulation/demodulation of physical channels, and multiple-input and multiple-output (MIMO) antenna processing, etc.

A UE (such as any of the UEs 150) in the network 100 may be pre-configured by RRC to perform configured grant transmission. That is, the UE is pre-configured with time-and-frequency resources for uplink data transmissions, without requesting a grant for such resources. Two types of configured grant transmissions are supported in NR. With the type-1 configured grant, a UE is configured with RRC without L1 signaling (e.g., DCI). With the type-2 configured grant, a UE is configured with RRC as well as L1 signaling (e.g., DCI). For example, the RRC configuration in the type-2 configured grant may contain information such as periodicity, power control-related parameters, and the number of repetitions (e.g., an integer number K) in each uplink transmission. The DCI in type-2 configured grant may contain information such as resource activation and/or release, time domain resource allocation, frequency domain resource allocation, etc.

NR supports multiple configurations for time domain and frequency domain resource allocations. With respect to time resources, a frame may be 10 milliseconds (ms) in length, and may be divided into ten subframes of 1 ms each. Each subframe may be further divided into multiple equal-length time slots (also referred to as slots), and the number of slots per subframe may be different in different configurations. Each slot may be further divided into multiple equal-length symbol durations (also referred to as symbols); e.g., 7 or 14 symbols. With respect to frequency resources, NR supports multiple different subcarrier bandwidths. Contiguous subcarriers (also referred to as resource elements (REs)) are grouped into one resource block (RB). In one configuration, one RB contains 12 subcarriers. A “carrier” as used herein refers to the bandwidth configured for a serving cell.

A UE may transmit uplink data in one or more transport blocks (TBs) concurrently. Each of these TBs may be assigned a HARQ process index or number identifying a corresponding HARQ process. Each HARQ process may be a configured grant HARQ process for configured grant transmission, or a grant-based HARQ process for grant-based transmission. A transport block may be segmented into code blocks before channel coding and rate matching. The code blocks are concatenated after rate matching.

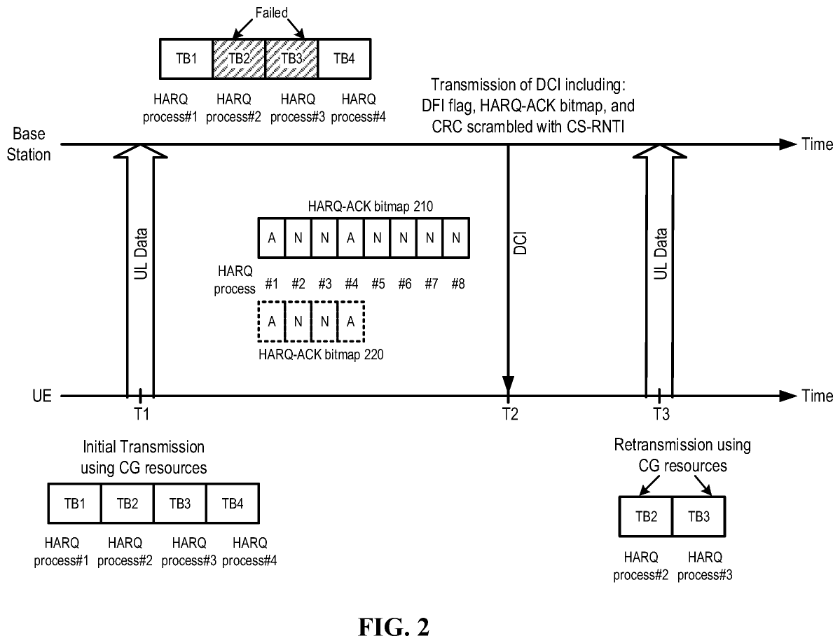

FIG. 2 illustrates uplink data re-transmission according to one embodiment. In this example, a UE uses configured grant resources for uplink data transmission. At time T1, the UE performs initial uplink transmission with a number of HARQ processes (e.g., four HARQ processes #1, #2, #3 and #4). A transport block is transmitted in each HARQ process. In one embodiment, the UE may send each transport block with K repetitions, where K is a pre-configured number.

After the UE transmits the transport blocks to the base station, the base station examines the received data to determine whether each transport block is received successfully. In this example, the receipt of TB1 and TB4 associated with HARQ processes #1 and #4 are successful, and the receipt of TB2 and TB3 associated with HARQ processes #2 and #3 are unsuccessful. In one embodiment, the base station generates a HARQ-ACK bitmap 210 for all of the uplink HARQ processes. For example, the UE may be provided with eight uplink HARQ processes, the first four of which are for the configured grant transmission performed at time T1. In the example of the HARQ-ACK bitmap 210, the last four of the eight uplink HARQ processes (e.g., HARQ processes #5, #6, #7 and #8) may be for configured grant transmission which are not performed at time T1. Since the last four uplink HARQ processes are not performed at time T1, the last four bits in the HARQ ACK bitmap 210 are set to the bit value representing NACK. Alternatively, the last four of the eight uplink HARQ processes may be for grant-based transmission, and their respective bit values may be set to indicate ACK or NACK of the respective grant-based HARQ processes. Thus, the HARQ ACK bitmap 210 illustrates an example in which all of the HARQ processes may include configured grant transmission only, or a combination of configured grant transmission and grant-based transmission.

In an alternative embodiment, the base station generates a HARQ-ACK bitmap 220 for a set of the uplink HARQ processes. In yet another embodiment, the base station generates the HARQ-ACK bitmap 220 for all of the uplink HARQ processes provided for configured grant transmission. The HARQ-ACK bitmap 220 is shown as blocks with dotted lines to indicate that the bitmap 220 is an embodiment alternative to the HARQ ACK bitmap 210. The UE is provided with eight uplink HARQ processes; however, the HARQ ACK bitmap 220 contains only four bits for four corresponding HARQ processes. These four HARQ processes may be a set (e.g., a subset) of the uplink HARQ processes. Alternatively, these HARQ processes may be all of the uplink HARQ processes provided for configured grant transmission. In the following description, the HARQ-ACK bitmap 210 is used as an example; however, it is understood that a different HARQ-ACK bitmap (e.g., the HARQ-ARK bitmap 220 or another bitmap) may be used.

In FIG. 2, bit 1 and bit 4 of the HARQ-ACK bitmap 210 corresponding to HARQ processes #1 and #4, respectively, are set to a first value to indicate ACK (successful transmission/reception). Bit 2 and bit 3 of the HARQ-ACK bitmap 210 corresponding to HARQ processes #2 and #3, respectively, are set to a second value to indicate NACK (unsuccessful transmission/reception). In one embodiment, the first value may be 1 and the second value may be 0. In an alternative embodiment, the first value may be 0 and the second value may be 1.

Prior to transmitting the DCI to a UE, the base station calculates an error detection code from the DCI payload, and appends a scrambled version of the error detection code to the DCI payload. In one embodiment, the error detection code is the CRC code, which is then scrambled with the CS-RNTI. The CS-RNTI is a pre-configured identifier of the UE or a group containing the UE. The DCI with CRC scrambled with CS-RNTI indicates to the receiving UE that the DCI contains information for configured grant uplink transmission.

At time T2, the base station sends the DCI to the UE. The DCI includes CRC bits scrambled with CS-RNTI and appended to the DCI payload. The DCI payload includes, among other elements, a HARQ-ACK bitmap (e.g., the HARQ-ACK bitmap 210) and a DFI flag set to a predetermined value (e.g., 1). The DFI flag indicates whether the DCI contains downlink feedback information e.g., a HARQ-ACK bitmap. When the DFI flag field is present in the DCI and is set to a predetermined value (e.g., 1), it indicates to the receiving UE that the DCI contains downlink feedback information; e.g., a HARQ-ACK bitmap for the HARQ processes.

If the HARQ-ACK bitmap indicates that all of the transport blocks are received successfully, the UE may use the next configured grant transmission occasion to send new transport blocks. In this example, the HARQ-ACK bitmap 210 indicates that HARQ processes #2 and #3 are to be re-transmitted. Thus, at time T3, the UE uses configured grant resources to re-transmit TB2 and TB3 according to the HARQ-ACK bitmap 210.

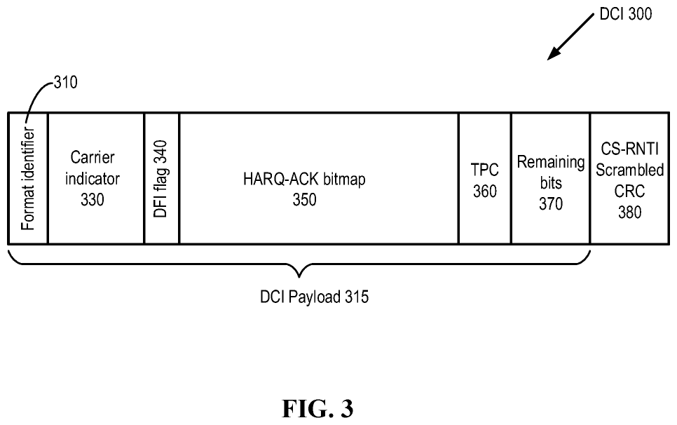

FIG. 3 is a diagram illustrating an example of DCI 300 according to one embodiment. The DCI 300 may be sent by a base station to a UE operating in a cell and configured to monitor a predetermined format (e.g., DCI format 0_X or, more specifically, DCI format 0_1) with CRC scrambled by CS-RNTI.

The DCI 300 includes a DCI payload 315 and CS-RNTI scrambled error detection bits (e.g., CRC bits) 380. The DCI payload 315 includes a DCI format identifier 310, a carrier indicator 330, a DFI flag 340, a HARQ-ACK bitmap 350, transmit power control (TPC) command 360, and a number of remaining bits 370.

The DCI format identifier 310 indicates whether the DCI is in an uplink DCI format (e.g., DCI format 0_X). In one embodiment, a base station sends DFI to a UE in a DCI having DCI format 0_1. When the DFI flag 340 is set to the bit value 1, DCI format 0_1 is used for indicating to a UE that the DCI contains DFI for configured grant transmission. In some embodiments, DCI format 0_X (e.g., DCI format 0_0, 0_1, or 0_2, etc.) may be used for sending DFI to a UE. The carrier indicator 330 may contain 0 or 3 bits

In one embodiment, the DFI flag 340 contains one bit; i.e., the DFI flag 340 is a 1-bit field. For DCI format 0_1 with CRC scrambled by CS-RNTI, the bit value of 0 indicates that the DCI is transmitted for other purpose, e.g., activation of type-2 configured grant transmission. The bit value of 1 indicates that the DCI 300 contains DFI for configured grant transmission. For DCI format 0_1 with CRC scrambled by an RNTI different from CS-RNTI (e.g., Cell RNTI (C-RNTI), Semi-Persistent Channel State Information RNTI (SP-CSI-RNTI) or Modulation Coding Scheme Cell RNTI (MCS-C-RNTI), the DFI flag bit is reserved. The DFI flag 340 may be absent in some alternative embodiments of DCI. If the DFI flag 340 is absent, it means that the DCI does not contain downlink feedback information for configured grant uplink transmission.

The DCI 300 includes a HARQ-ACK bitmap 350. In one embodiment, the HARQ-ACK bitmap 350 contains 16 bits, where the order of the bitmap 350 to HARQ process index mapping is such that HARQ process indices are mapped in ascending order from the most significant bit (MSB) to the least significant bit (LSB) of the bitmap 350. For each bit of the bitmap 350, the bit value 1 indicates ACK, and the bit value 0 indicates NACK. In another embodiment, the bit values indicating ACK and NACK may be reversed. The TPC command 360 controls transmit power for a scheduled PUSCH. The remaining bits 370 in the DCI 300 may be set to zero.

In one embodiment, the HARQ-ACK bitmap 350 corresponds to the transport blocks in the uplink data transmissions for all uplink HARQ processes for a serving cell of a PDCCH reception that provides DCI format 0_1. Alternatively, if DCI format 0_1 includes a carrier indicator field (e.g., the carrier indicator 330), the HARQ-ACK bitmap 350 corresponds to the transport blocks in the uplink data transmissions for all uplink HARQ processes for a serving cell indicated by a value of the carrier indicator field.

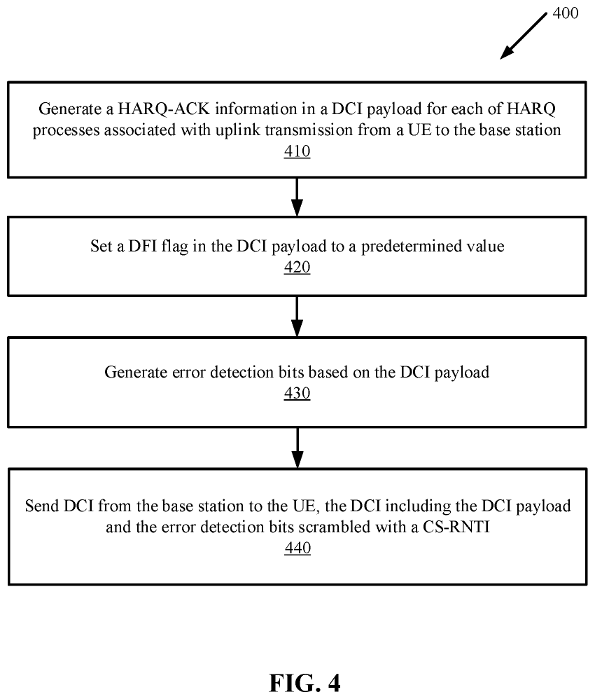

FIG. 4 is a flow diagram illustrating a method 400 for a base station to provide downlink feedback information to a UE in a wireless network according to one embodiment. The method 400 starts at step 410 when the base station generates HARQ-ACK information in a DCI payload. The HARQ-ACK information are generated for each of a plurality of HARQ processes associated with uplink transmission from the UE to the base station. In one embodiment, the HARQ-ACK information may be arranged as a bitmap with each bit indicating ACK or NACK for a corresponding HARQ process. At step 420, the base station sets a DFI flag in the DCI payload to a predetermined value (e.g., the bit value 1). At step 430, the base station generates error detection bits based on the DCI payload. In one embodiment, the error detection bits may be CRC parity bits. At step 440, the base station sends DCI to the UE, the DCI including the DCI payload and the error detection bits scrambled with a CS-RNTI. The CS-RNTI may be provided by an RRC configuration. The base station may perform channel coding (e.g., forward error correction) and rate matching before sending the DCI to the UE.

A UE can be configured a number of search space sets to monitor the PDCCH for detecting a DCI with a predetermined DCI 0_X format, with the DFI flag having a predetermined value, and with error detection bits scrambled with the CS-RNTI. In one embodiment, the UE verifies that the DCI has the DCI format 0_1. The UE descrambles the error detection bits with the CS-RNTI and verifies the correctness of the error detection bit value. The UE further verifies that the DFI flag is set to the predetermined value.

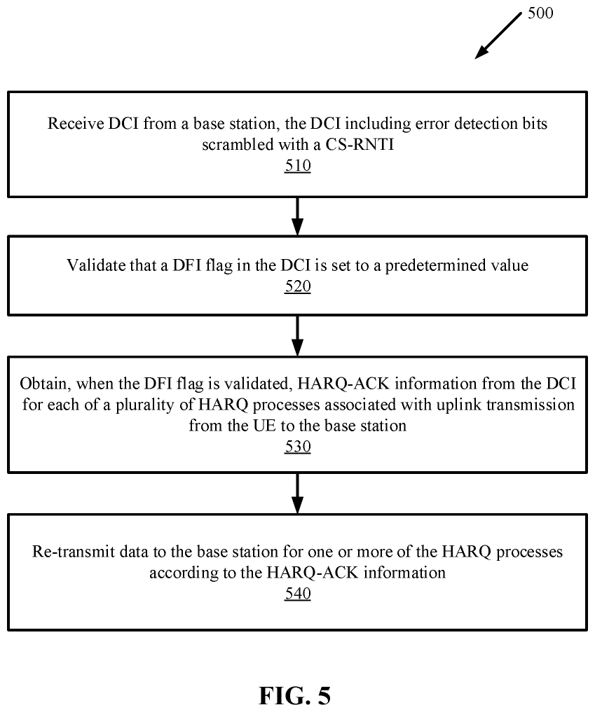

FIG. 5 is a flow diagram illustrating a method 500 for a UE to receive downlink feedback information from a base station in a wireless network according to one embodiment. The method 500 starts at step 510 when the UE receives DCI from the base station. The DCI includes error detection bits (e.g., CRC bits) scrambled with a CS-RNTI. The UE at step 520 validates that a DFI flag in the DCI is set to a predetermined value (e.g., the bit value 1). When the DFI flag is validated, the UE at step 530 obtains, HARQ-ACK information from the DCI for each of a plurality of HARQ processes associated with uplink transmission from the UE to the base station. The UE at step 540 re-transmits data to the base station for one or more of the HARQ processes according to the HARQ-ACK information.

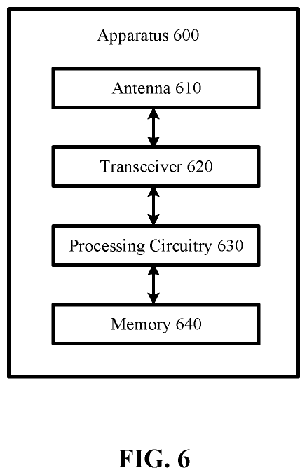

FIG. 6 is a block diagram illustrating elements of an apparatus 600 performing wireless communication according to one embodiment. The apparatus 600 may be any of the base stations 120 or any of the UEs 150 in FIG. 1.

As shown, the apparatus 600 may include an antenna 610, and a transceiver circuit (also referred to as a transceiver 620) including a transmitter and a receiver configured to provide radio communications with another station in a radio access network, including communication in an unlicensed spectrum. The transmitter and the receiver may include filters in the digital front end for each cluster, and each filter can be enabled to pass signals and disabled to block signals. The apparatus 600 may also include processing circuitry 630 which may include one or more control processors, signal processors, central processing units, cores, and/or processor cores. The apparatus 600 may also include a memory circuit (also referred to as memory 640) coupled to the processing circuitry 630. The apparatus 600 may also include an interface (such as a user interface). The apparatus 600 may be incorporated into a wireless system, a station, a terminal, a device, an appliance, a machine, and IoT operable to perform wireless communication in a cell with shared spectrum channel access, such as a 5G NR network. It is understood the embodiment of FIG. 6 is simplified for illustration purposes. Additional hardware components may be included.

In one embodiment, the apparatus 600 may store and transmit (internally and/or with other electronic devices over a network) code (composed of software instructions) and data using computer-readable media, such as non-transitory tangible computer-readable media (e.g., computer-readable storage media such as magnetic disks; optical disks; read-only memory; flash memory devices) and transitory computer-readable transmission media (e.g., electrical, optical, acoustical or other forms of propagated signals). For example, the memory 640 may include a non-transitory computer-readable storage medium that stores computer-readable program code. The code, when executed by the processors, causes the processors to perform operations according to embodiments disclosed herein, such as the method disclosed in FIG. 4 or FIG. 5.

Although the apparatus 600 is used in this disclosure as an example, it is understood that the methodology described herein is applicable to any computing and/or communication device capable of performing wireless communications.

The operations of the flow diagrams of FIGS. 4 and 5 have been described with reference to the exemplary embodiments of FIGS. 1 and 6. However, it should be understood that the operations of the flow diagrams of FIGS. 4 and 5 can be performed by embodiments of the invention other than the embodiments of FIGS. 1 and 6, and the embodiments of FIGS. 1 and 6 can perform operations different than those discussed with reference to the flow diagrams. While the flow diagrams of FIGS. 4 and 5 show a particular order of operations performed by certain embodiments of the invention, it should be understood that such order is exemplary (e.g., alternative embodiments may perform the operations in a different order, combine certain operations, overlap certain operations, etc.).

Various functional components or blocks have been described herein. As will be appreciated by persons skilled in the art, the functional blocks will preferably be implemented through circuits (either dedicated circuits, or general-purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for a base station to provide downlink feedback information (DFI) to a user equipment (UE) in a wireless network, comprising:
generating hybrid automatic repeat request (HARQ) acknowledgment (HARQ-ACK) information in a downlink control information (DCI) payload for each of a plurality of HARQ processes associated with uplink transmission from the UE to the base station;
setting a DFI flag in the DCI payload to a predetermined value;
generating error detection bits based on the DCI payload; and
sending DCI to the UE, the DCI including the DCI payload and the error detection bits scrambled with a configured scheduling radio network temporary identifier (CS-RNTI).

2. The method of claim 1, wherein the HARQ-ACK information indicate acknowledgment information for configured grant HARQ processes in the uplink transmissions from the UE to the base station.

3. The method of claim 1, wherein the HARQ-ACK information indicate acknowledgment information for configured grant HARQ processes and grant-based HARQ processes in the uplink transmissions from the UE to the base station.

4. The method of claim 1, wherein the HARQ-ACK information indicate acknowledgment information for all of the HARQ processes in the uplink transmissions from the UE to the base station.

5. The method of claim 1, wherein the DCI has a DCI format 0_X, X being 0, 1 or 2.

6. The method of claim 1, wherein the DFI flag is a 1-bit field.

7. The method of claim 1, wherein, for the DCI having a DCI format 0_1 with the error detection bits scrambled by the CS-RNTI, the DFI flag with a predetermined binary value in the DCI payload indicating that the DCI includes the DFI.

8. The method of claim 1, wherein the DFI flag is reserved for the DCI having a DCI format 0_1 with the error detection bits scrambled by an RNTI different from the CS-RNTI.

9. The method of claim 8, wherein the RNTI different from the CS-RNTI includes one of following: cell RNTI (C-RNTI), semi-persistent channel state information RNTI (SP-CSI-RNTI) and modulation coding scheme cell RNTI (MCS-C-RNTI).

10. The method of claim 1, wherein the HARQ-ACK information are provided in a bitmap having a plurality of bits with each bit corresponding to one of the HARQ processes, wherein a first binary value indicates acknowledgment (ACK) and a second binary value indicate negative acknowledgment (NACK).

11. The method of claim 10, wherein indices of the HARQ processes are mapped in an ascending order to the bitmap from the most-significant bit (MSB) to the least-significant bit (LSB) of the bitmap.

12. A method for a UE to receive downlink feedback information (DFI) from a base station in a wireless network, comprising:
receiving downlink control information (DCI) from the base station, the DCI including error detection bits scrambled with configured scheduling radio network temporary identifier (CS-RNTI);
validating that a DFI flag in the DCI is set to a predetermined value;
obtaining, when the DFI flag is validated, HARQ-ACK information from the DCI for each of a plurality of HARQ processes associated with uplink transmission from the UE to the base station; and
re-transmitting data to the base station for one or more of the HARQ processes according to the HARQ-ACK information.

13. The method of claim 12, wherein the HARQ-ACK information indicate acknowledgment information for configured grant HARQ processes in the uplink transmissions from the UE to the base station.

14. The method of claim 12, wherein the HARQ-ACK information indicate acknowledgment information for configured grant HARQ processes and grant-based HARQ processes in the uplink transmissions from the UE to the base station.

15. The method of claim 12, wherein the HARQ-ACK information indicate acknowledgment information for all of the HARQ processes in the uplink transmissions from the UE to the base station.

16. The method of claim 12, wherein the DCI has a DCI format 0_X, X being 0, 1 or 2.

17. The method of claim 12, wherein, for the DCI having a DCI format 0_1 with the error detection bits scrambled by the CS-RNTI, the DFI flag with a predetermined binary value in the DCI payload indicating that the DCI includes the DFI.

18. The method of claim 12, wherein the DFI flag is reserved for the DCI having a DCI format 0_1 with the error detection bits scrambled by an RNTI different from the CS-RNTI, wherein the RNTI different from the CS-RNTI includes one of following: cell RNTI (C-RNTI), semi-persistent channel state information RNTI (SP-CSI-RNTI) and modulation coding scheme cell RNTI (MCS-C-RNTI).

19. The method of claim 12, wherein the HARQ-ACK information are provided in a bitmap having a plurality of bits with each bit corresponding to one of the HARQ processes, wherein a first binary value indicates acknowledgment (ACK) and a second binary value indicate negative acknowledgment (NACK).

20. The method of claim 19, wherein indices of the HARQ processes are mapped in an ascending order to the bitmap from the most-significant bit (MSB) to the least-significant bit (LSB) of the bitmap.
